(19) United States
(12) Patent Application Publication
(10) Pub. No.: US 2018/0137270 A1
(43) Pub. Date: May 17, 2018

(54) METHOD AND APPARATUS FOR NON-INTRUSIVE PROGRAM TRACING FOR EMBEDDED COMPUTING SYSTEMS

(71) Applicants: Carlos Moreno, Waterloo (CA); Sebastian Fischmeister, Waterloo (CA)

(72) Inventors: Carlos Moreno, Waterloo (CA); Sebastian Fischmeister, Waterloo (CA)

(21) Appl. No.: 15/814,073

(22) Filed: Nov. 15, 2017

Related U.S. Application Data
(60) Provisional application No. 62/422,565, filed on Nov. 15, 2016.

(51) Int. Cl. G06F 21/52

(52) U.S. Cl. CPC G06F 21/52; G06F 2221/033

(57) ABSTRACT

Systems and methods for non-intrusive program tracing of a device are disclosed. The method includes providing a database storing a plurality of candidate samples, each of the candidate samples being associated with at least one of a known portion of program code and an observed behavior; generating an analog program trace signal from at least one of power consumption and electromagnetic emission of the device; digitizing the analog program trace signal into a digital program trace signal; collecting a fragment of the digital program trace signal; using hardware to determine a distance between the fragment with each of the candidate samples simultaneously; determining if the distance between the fragment and at least one of the candidate samples satisfies a pre-determined criterion; and in response to determining that the pre-determined criterion is satisfied, classifying the fragment as one of the candidate samples, based on the distance between the fragment with each of the candidate samples.

### FIELD

The embodiments described herein relate to the field of embedded computing systems, and in particular, side-channel analysis of embedded computing systems for security, safety, and development.

### BACKGROUND

Security and safety can be essential aspects of embedded computing systems, especially safety-critical systems, and in view of the ever-increasing connectivity of such systems. Traditionally, safety-critical systems have used runtime monitoring techniques to enforce security and safety properties during operation. However, monitoring security and safety properties poses unique challenges. The functionality of safety-critical systems should not be disrupted by such monitoring. In addition, firmware reprogramming can bypass a monitoring tool if it runs alongside the monitored and vulnerable system. Furthermore, if malware runs on the same processor as the monitoring tool, then malware can “fake” behaviors that the monitoring tool will consider acceptable.

In addition, debugging can be a difficult aspect of embedded software development, particularly at the production or deployment stage. By the time that faults are observed at the production or deployment stage, tools for debugging are limited. Typically, auxiliary components that can aid debugging have been removed from the software prior to production or deployment and cannot be added back in.

Some existing security and safety monitoring and debugging techniques are based on side-channel analysis, that is, correlating instructions that a microprocessor is executing with side-effects of the microprocessor during execution, such as power consumption and electromagnetic emissions. Reconstructing program traces in these techniques can involve standard statistical pattern recognition techniques, hidden Markov models, or signal processing approaches including ideas from the pattern recognition field. Such data processing is typically performed offline and “manually” by an operator.

### SUMMARY

In a first aspect, there is a system for non-intrusive program tracing of a device. In at least one embodiment, the system includes: a database storing a plurality of candidate samples; a detector operable to generate an analog program trace signal from at least one of power consumption and electromagnetic emission of the device; a converter operable to digitize the analog program trace signal into a digital program trace signal; a hardware-based comparator in communication with the database, a processor operable to classify the fragment as one of the candidate samples. Each of the candidate samples can be associated with at least one of a known portion of program code and an observed behavior. The hardware-based comparator is operable to collect fragments of the digital program trace signal and to determine a distance between a fragment with each of the candidate samples simultaneously. The processor determines if the distance between the fragment and at least one of the candidate samples satisfies a pre-determined criterion. In response to determining that the pre-determined criterion is satisfied, the processor classifies the fragment as one of the candidate samples based on the distance between the fragment with each of the candidate samples.

In some aspects, the hardware-based comparator can include a first-in-first-out buffer for collecting fragments. The first-in-first-out buffer can have a length. Each of the plurality of candidate samples can have a length that is shorter than or equal to the length of the first-in-first-out buffer.

In some aspects, each candidate sample and each fragment can include an ordered set of values. The hardware-based comparator can include a plurality of difference operators and a plurality of summation operators. Each difference operator can determine a unit difference between a value of the fragment and a value of the candidate sample having a same position within the ordered set of each of the candidate samples. Each summation operator can determine the distance between the fragment with one of the plurality of candidate samples based on the unit differences.

In some aspects, the lengths of each of the candidate samples can be equal.

In some aspects, the lengths of at least two of the candidate samples are unequal.

In some aspects, the detector can include a shunt resistor connected in series with a power line of the device. The converter can include at least one of an analog to digital converter and a contactless current sensor.

In some aspects, the detector can include an antenna. The detector can further include an amplifier cascaded with the antenna.

In some aspects, the hardware-based comparator can include at least one of a field programmable gate array, an application-specific integrated circuit, a digital signal processor, an array of microcontrollers and external memory, and a circuit based on discrete digital components.

In some aspects, the hardware-based comparator can include a Discrete Fourier Transform calculator for determining a Discrete Fourier Transform of the fragment prior to determining a distance between the fragment with each of the candidate samples.

In some aspects, the processor can determine if the distance between the fragment and at least one of the candidate samples is less than a pre-determined distance threshold.

In some aspects, the processor can classify the fragment of the digital program trace signal as the known program fragment sample having a distance with the fragment that is less than or equal to the distance of each of the other known program fragment samples with the fragment.

In some aspects, the processor can store the fragment as a candidate sample in the database in response to determining that the pre-determined criterion is not satisfied.

In another aspect, there is a method for non-intrusive program tracing a device. The method can involve providing a database storing a plurality of candidate samples; generating an analog program trace signal from at least one of power consumption and electromagnetic emission of the device; digitizing the analog program trace signal into a digital program trace signal; collecting a fragment of the digital program trace signal; using hardware to determine a distance between the fragment with each of the candidate samples simultaneously; and classifying the fragment as one of the candidate samples, based on the distance between the fragment with each of the candidate samples.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a diagram of a system for non-intrusive program tracing, using power tracing, for an embedded computing system, according to at least one embodiment;

FIG. 2 is a diagram of an architecture for a hardware-based comparator 140 in accordance with at least one embodiment;

FIG. 3 is a diagram of another system for non-intrusive program tracing, using power tracing, for an embedded computing system, according to at least one embodiment;

FIG. 4 is a diagram of a system for non-intrusive program tracing, using electromagnetic emissions tracing, for an embedded computing system, according to at least one embodiment;

FIG. 5 is a flowchart of a method for non-intrusive program tracing for an embedded computing system, according to at least one embodiment;

FIG. 6 is a diagram of an architecture for a hardware-based comparator including pre-processing in accordance with at least one embodiment;

FIG. 7 is a screen shot of a power trace, in accordance with at least one embodiment; and

FIG. 8 is a screen shot of another power trace, in accordance with at least one embodiment.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Non-intrusive program tracing can be achieved by monitoring side-effects, such as power consumption or EM emissions, of an embedded computing system as it executes a program. Power consumption or EM emission measurements as a function of time can be referred to as power traces or EM emissions traces, or more generally, program traces. The program traces can be correlated to program code executed by the embedded computing system or observed behavior of the embedded computing system during the program trace, in order to determine the sequence of executed instructions that the embedded computing system executed.

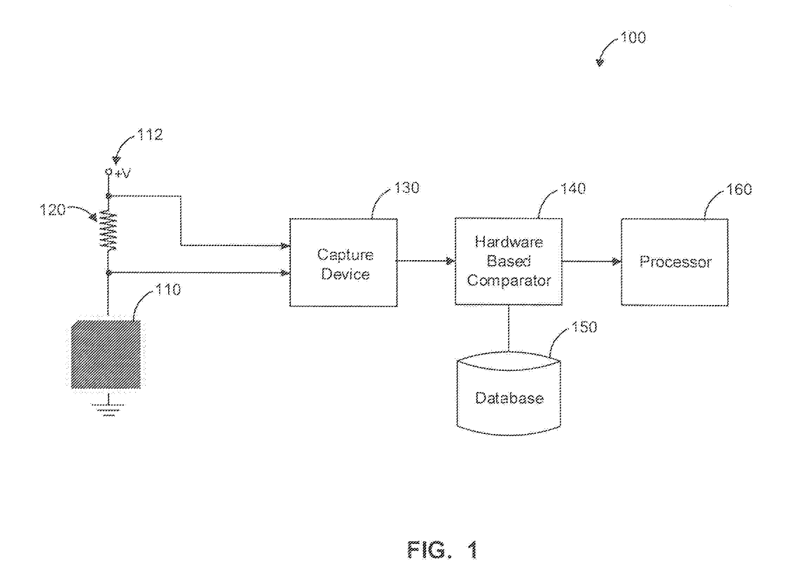

Referring to FIG. 1, shown therein is a diagram of a system 100 for non-intrusive program tracing for an embedded computing system, according to at least one embodiment. The system 100 can perform program tracing, and more specifically, power tracing of the embedded computing system 110. The system 100 includes a resistor 120, a capture device 130, a hardware-based comparator 140, a database 150, and a processor 160.

In at least one embodiment, the embedded computing system 110 can be a microprocessor, memory chips, or interface circuits. The embedded computing system 110 can receive power from power input line 112.

In at least one embodiment, a resistor 120 can be placed in series with the power input line of the embedded computing system 110. As shown in FIG. 1, the resistor 120 can be located outside of the computing system 110. In at least one embodiment, resistor 120 can be placed inside the embedded computing system 110. An analog signal indicative of the power consumption of the embedded computing system 110, or the power trace, can be obtained by measuring current or voltage across the resistor 120. In this manner, the resistor can act as a detector of the power consumption.

The capture device 130 can measure current across the resistor 120 in order to obtain the power trace. In addition, the converter 130 can digitize the power trace. In at least one embodiment, the capture device 130 can be a contactless current sensor. In at least one embodiment, the capture device 130 can be an analog-to-digital converter. In at least one embodiment, the capture device 130 can be a sound card. In at least one embodiment, the capture device 130 can be an oscilloscope. In at least one embodiment, the capture device 130 can be a digital oscilloscope.

The hardware-based comparator 140 can receive the digital power trace from the capture device 130. In some embodiments, the hardware-based comparator 140 can continuously receive and process the digital power trace from the capture device 130. That is, the hardware-based comparator 140 can receive and process each sample of the digital power trace. In some embodiments, the hardware-based comparator 140 can process a downsampled version of the digital power trace. That is, the hardware-based comparator 140 can receive each sample of the digital power trace and then process every “N” samples. The downsampling ratio, “N”, can be a value small enough to ensure high granularity and thus “continuous” processing.

The hardware-based comparator 140 can include a first-in-first-out (FIFO) buffer. The FIFO buffer can store fragments of current and past samples of the digital program trace for comparison with candidate samples stored in database 150. The length of the FIFO buffer can relate to the length of the longest candidate sample stored in the database 150. In some embodiments, the length of the longest candidate sample can correspond to the portion of program code exhibiting the longest execution time. A fragment of the digital program trace can be compared with each candidate sample in the database 150 in order to determine the portion of program code that the digital program trace corresponds to. The comparison can generate a distance or a measure of the fragment of the digital program trace with a candidate sample from the database 150.

In some embodiments, the FIFO buffer can have a varying length. For example, in a first instance, the FIFO buffer can have a first length and in a second instance, the FIFO buffer can have a second length that is different from the first length.

The database 150 can store candidate samples in association with, or linked with, known portions of program code and/or observed behavior. The database 150 can be created during a training stage in which program traces are obtained for known portions of program code and/or observed behavior. That is, a portion of program code can be executed in order to generate and obtain a candidate sample. Furthermore, a portion of program code can be executed multiple times to obtain multiple candidate samples for the known portion of program code and/or observed behavior. In some embodiments, the database 150 can also be updated with additional candidate samples after the training stage.

In some embodiments, candidate samples can vary in length. In such cases, multiple candidate samples for a given portion of program code and/or observed behavior can be stored. Each candidate sample can be labelled with the corresponding portion of program code and/or observed behavior and stored in the database 150.

In some embodiments, portions of program code can be selected such that all candidate samples corresponding to a given portion of program code have a fixed length. That is, each of the candidate samples can have equal lengths. In such cases, a mean, or an average of multiple candidate samples for a given portion of program code can be stored. The mean candidate sample can then be labeled with the corresponding portion of program code and stored in the database 150.

Similarly, in some embodiments, the fragments extracted directly from the power trace based on observed behaviors or patterns can be selected such that all candidate samples for a given behavior or pattern have a fixed length.

In some embodiments, instead of storing candidate samples, the database 150 can be a model representing the program trace (e.g., power consumption or EM emissions) as a function of the corresponding executed portion of program code and/or observed behavior.

The processor 160 can include memory to store computer programs that are executable by the processor 160 (e.g. using the memory). In some embodiments, processor 160 can execute computer programs that implement a classifier. The processor 160 can receive the distances of a fragment of the digital program trace to each candidate sample. In turn, the processor 160 can determine which candidate sample the fragment corresponds to.

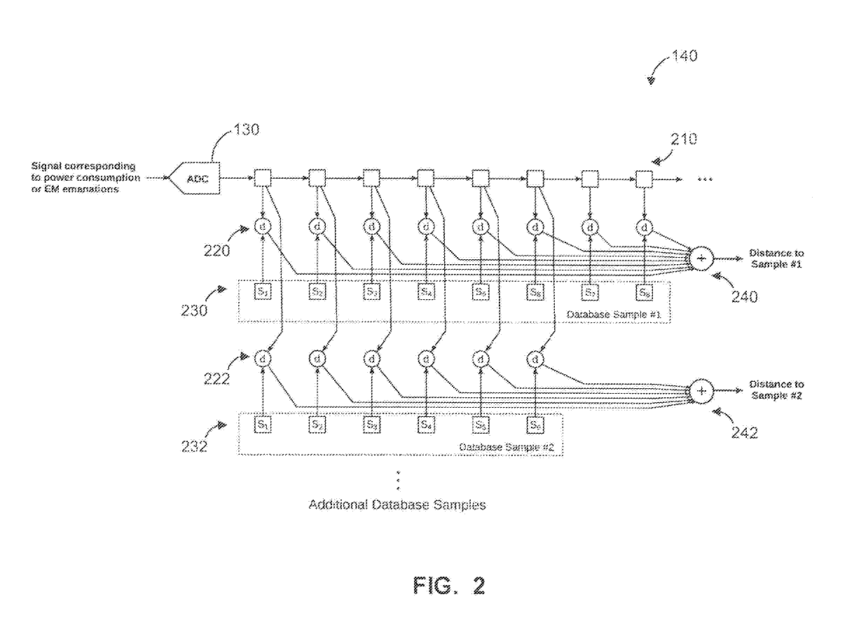

Referring to FIG. 2, shown therein is a diagram of an architecture for a hardware-based comparator 140 in accordance with at least one embodiment. The hardware-based comparator 140 can evaluate distances 220 and 222 between a fragment 210 of the digital program trace and candidate samples 230 and 232 stored in the database 150 (shown as “database sample”). Furthermore, the hardware-based comparator 140 can evaluate a distance 220 between a fragment 210 of the program trace and each of candidate samples 230 and 232, simultaneously.

While FIG. 2 only shows two candidate samples 230 and 232, it is understood that any number of candidate samples 230 and 232 can be compared simultaneously. That is, each of candidate samples 230 and 232 can be compared with a fragment 210 simultaneously (i.e., “in parallel”). In some embodiments, the comparison of each of candidate samples 230 and 232 with fragment 210 can be performed in sequence (i.e., “pipelined” or “in series”).

As shown in FIG. 2, each of candidate samples 230 and 232 is an ordered set of values. Candidate samples 230 and 232 can have different lengths: candidate sample 230 includes eight values while candidate sample 232 can includes six values.

In FIG. 2, operators 220 and 222 are generally distance operators that compute a difference between two values. Operators 220 and 222 can implement various operations based on the difference. For example, operators 220 and 222 can implement the square of the difference between the two values, or the absolute value of the difference between the two values. Operators 220 and 222 are generally the same operation. That is, if operator 220 determines the absolute value of the difference between two values, operator 222 also determines the absolute value of the difference between two values.

In FIG. 2, operators 240 and 242 can implement a weighted sum. A weighted sum can be the sum of all of its inputs scaled by a certain factor, or the average of all of its inputs, or in general, any linear combination of the inputs.

In some embodiments, the hardware-based comparator 140 can be implemented on a field-programmable gate array (FPGA). In some embodiments, the hardware architecture can be implemented on an application-specific integrated circuit (ASIC). In some embodiments, the hardware architecture can be implemented based on digital signal processors. In some embodiments, the hardware architecture can be implemented based an array of microcontrollers and/or external memory. In some embodiments, the hardware architecture can be implemented based on discrete digital components.

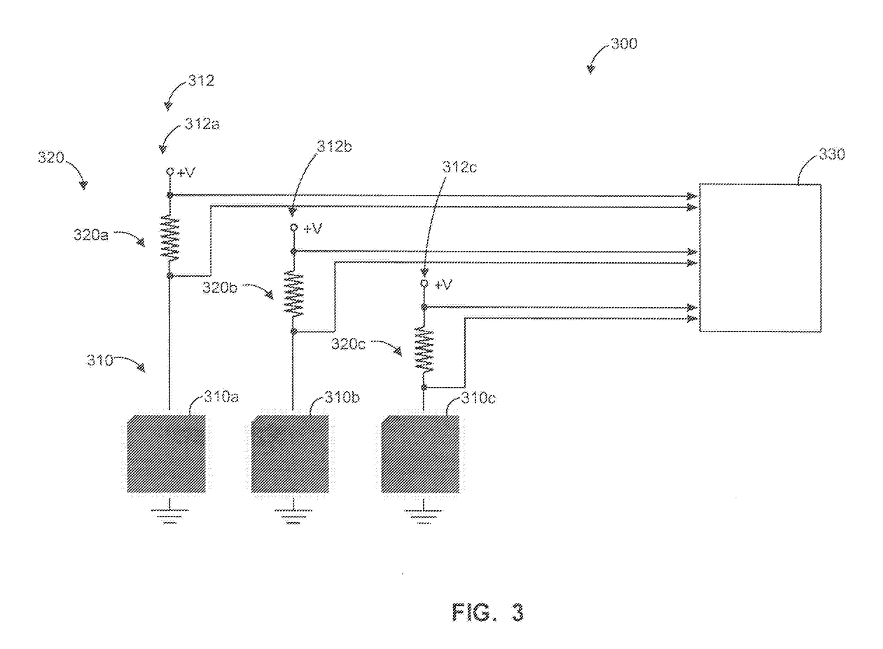

Referring to FIG. 3, shown therein is a diagram of another system 300 for non-intrusive program tracing for an embedded computing system 310, according to at least one embodiment. The system 300 can perform multiple power traces. The system 300 includes resistors 320 (as shown in FIG. 3, the resistors 320a, 320b, and 320c may be collectively referred to as the resistors 320), a multi-capture device 330. While not shown in FIG. 3, the system 300 also includes a hardware-based comparator 140, a database 150, and a processor 160, similar to that of system 100.

As shown in FIG. 3, a resistor 320 is placed in series with each of the power input lines 312 (as shown in FIG. 3, the power lines 312a, 312b, and 312c may be collectively referred to as the power lines 312).

In some embodiments, the multiple power lines 312 relate to a single embedded computing system 310. For example, the single embedded computing device 310 can be a multi-core processor that operates with different voltages and/or different power requirements requiring separate power-In lines. In another example, a standard PC can include a motherboard having a power connection with multiple power lines.

In some embodiments, the multiple power lines 312 relate to multiple embedded computing systems 310 (as shown in FIG. 3, the embedded computing systems 310a, 310b, and 310c may be collectively referred to as the power lines 310). For example, the system 300 can monitor the power consumed by a microprocessor, the power consumed by external memory chips, and/or the power consumed by external interface circuits, etc.

Monitoring multiple power lines can increase the accuracy of the classifier as it provides additional sample points for a portion of program code. In some embodiments, multiple power lines can be treated as a vector (e.g., multi-dimensional signal). A fragment from each power line can be compared with a respective candidate sample in parallel.

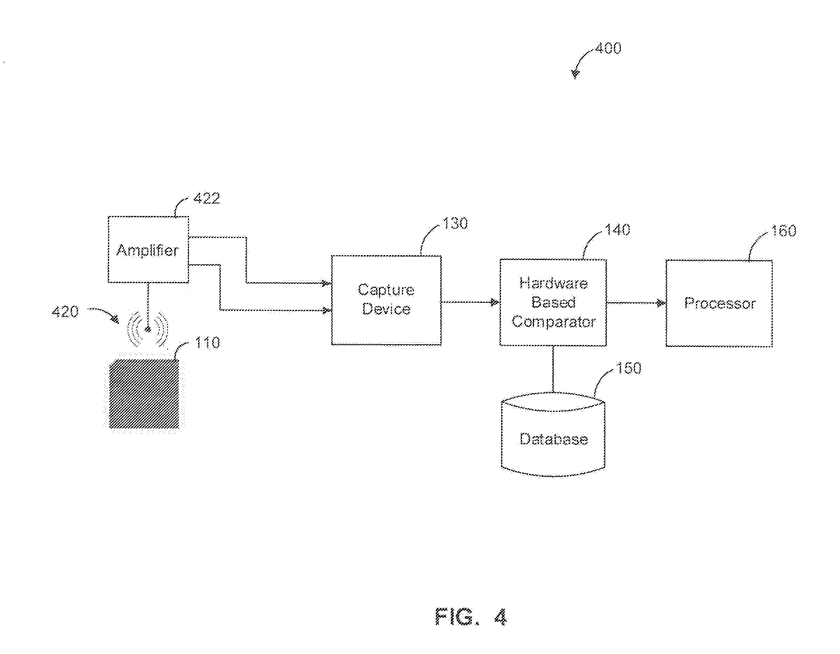

Referring to FIG. 4, shown therein is a diagram of a system 400 for non-intrusive program tracing for an embedded computing system, according to at least one embodiment. The system 400 can perform electromagnetic (EM) emissions tracing of the embedded computing system 110. The system 400 includes an antenna 420, an amplifier 422, a capture device 130, a hardware-based comparator 140, a database 150, and a processor 160.

In at least one embodiment, an antenna 420 can be placed in the vicinity of the embedded computing system 110 to detect electromagnetic emissions of the embedded computing system 110. In some embodiments, additional signal conditioning is required in order to provide a signal within the operating range of the capture device 130. In some embodiments, the antenna 420 can be cascaded with an amplifier 422 to increase the strength of the signal from the antenna 420. In such cases, it is understood that the antenna 420 acts as a detector of the electromagnetic emissions.

As indicated by common reference numerals, the capture device 130, hardware-based comparator 140, database 150, and processor 160 of system 400 are similar to those of system 100. Also similar to power tracing, EM emissions tracing can be performed with a single probe to capture a single EM emissions trace, such as system 100, or with multiple probes to capture multiple EM emissions traces, such as system 300. Multiple EM emissions traces can relate to multiple independent components or different areas of a single component.

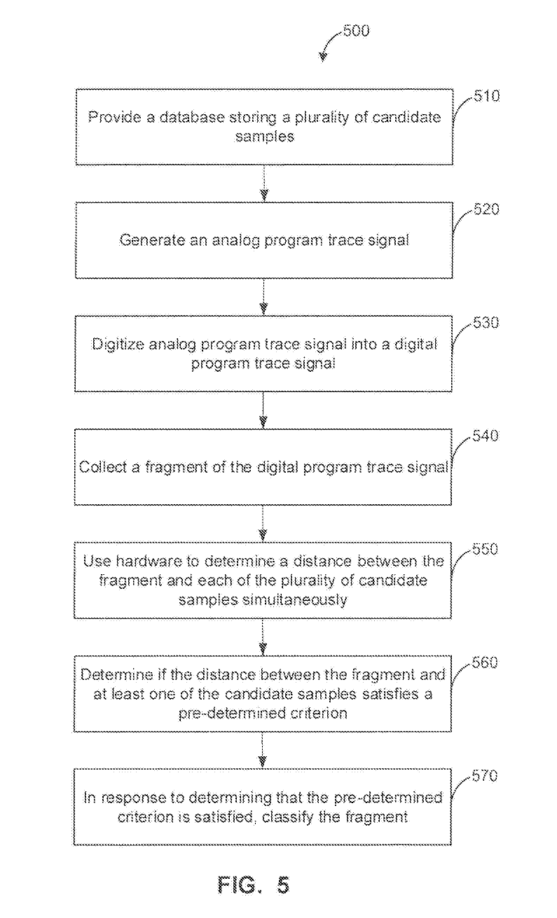

Referring to FIG. 5, shown therein is a method 500 of non-intrusive program tracing for an embedded computing system.

Initially, at step 510, a database 150 storing a plurality of candidate samples is provided. Each candidate sample can be associated with a known portion of program code. A plurality of candidate samples can be associated with a particular portion of program code.

At step 520, an analog program trace signal of the device is obtained. In some embodiments, the analog program trace signal can be indicative of the power consumption of the device. A power trace of a device can be obtained by the current of a shunt resistor placed in series with a power line of the device. In some embodiments, the analog program trace signal can be indicative of electromagnetic emissions of the device. An antenna cascaded with an amplifier can detect the electromagnetic emissions of the device.

At step 530, the analog program trace signal of step 520 is digitized to obtain a digital program trace signal. The digital program trace signal can be obtained by any appropriate device including, but not limited to, an analog-to-digital converter, a contactless current sensor, an oscilloscope, or a sound card.

At step 540, a fragment 210 of the digital program trace is collected. A first-in-first-out (FIFO) buffer can be used to collect the fragment 210 in order to have access to the current sample and past samples. The number of past samples held by the FIFO buffer is a design parameter of the buffer; that is, the length of the buffer. The length of the buffer can be determined for each target system being monitored. Generally, the length of the longest candidate sample stored in the database can be selected as the length of the buffer.

At step 550, a distance between the fragment 210 and each of the candidate samples stored in the database can be simultaneously determined using hardware. For each candidate sample, a distance between the fragment 210, that is the program trace at the current position, and the candidate sample is evaluated. This step is performed using hardware so that all of the elements in the fragment 210 are processed simultaneously and a distance to each candidate sample is output at each time index (a time index refers to one analog sample of the power trace, taken by the analog-to-digital converter, and it corresponds to a position in the power trace). This output is, thus, the distance to the candidate sample as a function of the position where the match is attempted.

At step 560, the distances of step 550 can be compared with a pre-determined criterion in order to determine whether the fragment can be classified as a candidate sample of the database. In some embodiments, a fragment can relate to unknown behavior or program code and the unknown behavior or program code may not correspond to any candidate samples in the database. When the fragment does not relate to known program code or prior observed behavior, the fragment code may not be classified. Instead, the fragment can be stored in the database as an additional candidate sample. After the fragment is stored in the database, the fragment, as an additional candidate sample, can be used for future classifications.

The pre-determined criterion can be any appropriate criterion. In some embodiments, the pre-determined criterion can be a distance threshold. In order to be classified, the distance between the fragment and a candidate sample must be less than the distance threshold.

At step 570, a classification based on the distances of step 550 can be determined. Each fragment 210 of the digital program traces can be classified as one of the plurality of candidate samples stored in the database, based on the distance between the fragment 210 and each of the candidate samples. Any appropriate algorithm can be used determine a classification based on each of the distances received. Algorithms can include but is not limited to correlation analysis, mutual information analysis, statistical processing, including system identification, and pattern recognition techniques. In addition, prior to classification, additional processing can be performed to filter and enhance the captured data (e.g., reduce measurement noise) and to extract spectral information for the statistical processing phase. Such additional processing can be digital signal processing techniques.

In at least one embodiment, a classification can be made based on the smallest distance determined at step 550. That is, the fragment can be classified as the candidate sample having a distance with the fragment that is less than or equal to the distance of each of the other candidate samples.

In at least one embodiment, a classification can be made based on the sequence of the distances determined at step 550. That is, the classification can be made based on the temporal order of the distance determined at step 550 for the fragment 210 and past fragments.

In at least one embodiment, the classification can use auxiliary information. Auxiliary information can be used to identify a subset of candidate samples that the fragment 210 can be classified as. Any available auxiliary information can be used. In some embodiments, auxiliary information can reduce the classification processing time. In some embodiments, auxiliary information can increase the accuracy of the classification.

For example, in some embodiments, auxiliary information can include rules that identify subsets of candidate samples given the feasible sequences according to the source code of the program. That is, by inspecting the source code of the program, it may be known that after executing program code associated with candidate sample 1, the subsequent program code can only be program code associated with candidate sample 5 or candidate sample 7. This means that the classifier, after having identified candidate sample 1, can re-run the classifier with subset of the database that contains only candidate samples 5 and 7 because it is known that candidate samples 5 and 7 are the only possible candidates.

In some embodiments, the classification involves software executed by the processor 160 to process the outputs from the hardware-based comparator 140. In some embodiments, the software can also drive multiplexers in the hardware-based comparator 140 to compute the distance between the fragment 210 and different sets of candidate samples.

In some embodiments, the fragment 210 can be processed prior to determination of the distance between the fragment 210 and each of the candidate samples. Pre-processing of the fragment 210 prior to comparison can reduce noise that occurs between fragments 210. As a result, the comparison is less sensitive to the actual position at which the comparison is made.

In some embodiments, the classification can be facilitated by the addition of markers in the program code. Markers can be added in the program code so that they generate easily identifiable portions of the program trace. Markers can be special fragments of program code that have no significant effect on the outcome of the program but generate easily identifiable program traces.

In some embodiments, the classification can be facilitated by strategic arrangement of the program code. More specifically, the program code can be arranged in a manner that does not affect the outcome of the program but such that different portions of program code will produce program traces that are very different, such that they are easily distinguishable by the classifier.

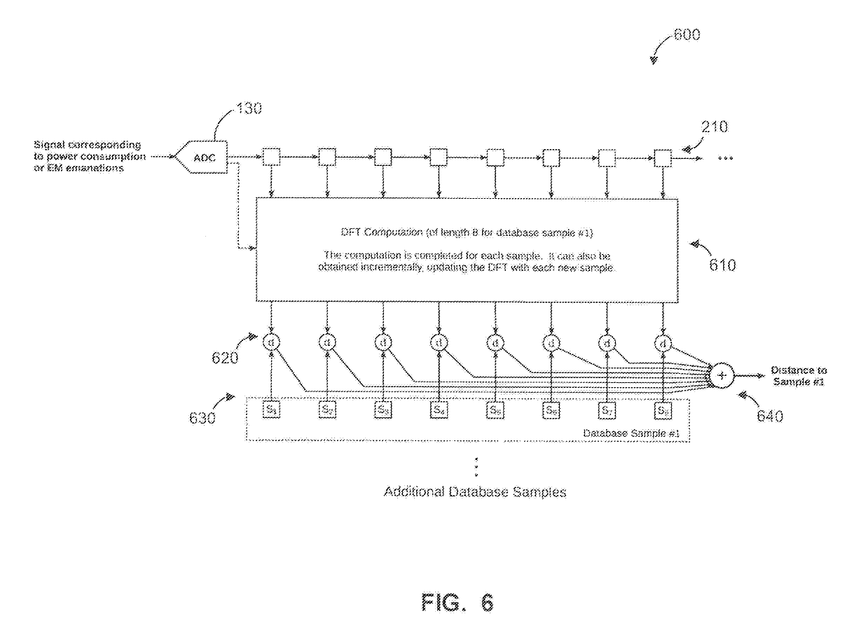

Referring to FIG. 6, shown therein is a diagram of an architecture 600 for a hardware-based comparator 140 including a pre-processor 610 in accordance with at least one embodiment. The pre-processor 610 can include any appropriate transformation.

In at least one embodiment, the pre-processor 610 can include a Discrete Fourier Transform (DFT). In at least one embodiment, the DFT can be computed through Fast Fourier Transform. In at least one embodiment, the DFT can be computed incrementally, by updating the DFT as a result of shifting the samples, eliminating the first sample and adding a new one. The resulting values can be expressed in a plurality of formats. In at least one embodiment, for example, the distance computation can receive the raw complex number and output the magnitude of the difference. In at least one embodiment, the distance computation can use the complex logarithm of each value, to compare the pairs <logarithmic magnitude, phase> in the Euclidean sense.

In at least one embodiment, the pre-processor 610 can include a dimensionality reduction derived from Principal Component Analysis (PCA).

Non-intrusive program tracing can allow for the reconstruction of a program trace of a deployed embedded device. In some embodiments, non-intrusive program tracing can also be used for software debugging at late stages of the development or even after deployment.

In some embodiments, non-intrusive program tracing can be implemented as a runtime monitor to enforce both safety and security properties of the device. In some embodiments, program tracing of a deployed embedded device can be used in an Intrusion Detection System (IDS) based on non-intrusive monitoring of the device's operation at a granularity level as fine as the program trace.

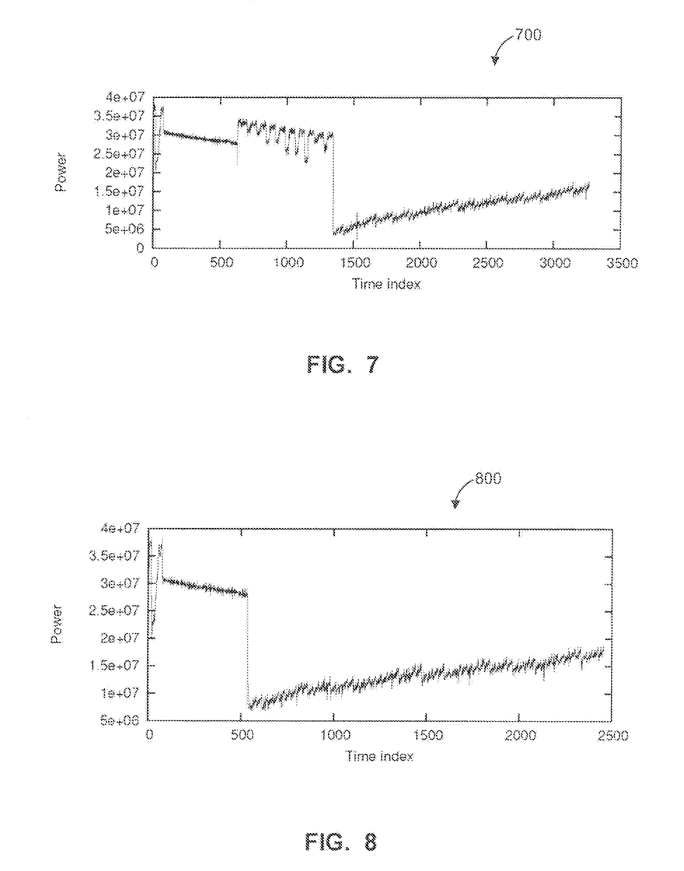

Referring now to FIGS. 7 and 8, shown there are screenshots of power traces 700 and 800, in accordance with at least one embodiment. A microprocessor may provide access control to other devices. The microprocessor can execute program code to grant access when a device is determined to be genuine, or deny access when a device is determined to not be genuine.

An IDS can monitor the power trace of the microprocessor. Power trace 700 shows the microprocessor as it executes program code for authenticating a genuine device at approximately time index 600-1400. In contrast, power trace 800 shows the microprocessor as it fails the authentication and does not execute the program code related to authentication.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A system for non-intrusive program tracing of a device comprising:
(a) a database storing a plurality of candidate samples, each of the candidate samples being associated with at least one of a known portion of program code and an observed behavior;
(b) a detector operable to generate an analog program trace signal from at least one of power consumption and electromagnetic emission of the device;
(c) a converter operable to digitize the analog program trace signal into a digital program trace signal;
(d) a hardware-based comparator in communication with the database, the hardware-based comparator operable to collect fragments of the digital program trace signal and to determine a distance between a fragment with each of the candidate samples simultaneously; and
(e) a processor operable to:
determine if the distance between the fragment and at least one of the candidate samples satisfies a pre-determined criterion; and
in response to determining that the pre-determined criterion is satisfied, classify the fragment as one of the candidate samples, based on the distance between the fragment with each of the candidate samples.

2. The system of claim 1 wherein:
the hardware-based comparator comprises a first-in-first-out buffer for collecting fragments, the first-in-first-out buffer having a length, and
each of the plurality of candidate samples have a length that is shorter than or equal to the length of the first-in-first-out buffer.

3. The system of claim 2 wherein:
(a) each candidate sample and each fragment comprises an ordered set of values; and
(b) the hardware-based comparator comprises:
(i) a plurality of difference operators, each difference operator for determining a unit difference between a value of the fragment and a value of the candidate sample having a same position within the ordered set of each of the candidate samples; and
(ii) a plurality of summation operators, each summation operator for determining the distance between the fragment with one of the plurality of candidate samples based on the unit differences.

4. The system of claim 2 wherein the lengths of each of the candidate samples are equal.

5. The system of claim 2 wherein the lengths of at least two of the candidate samples are unequal.

6. The system of claim 1 wherein the detector comprises a shunt resistor connected in series with a power line of the device.

7. The system of claim 6 wherein the converter comprises at least one of an analog to digital converter and a contactless current sensor.

8. The system of claim 1 wherein the detector comprises an antenna.

9. The system of claim 8 wherein the detector further comprises an amplifier cascaded with the antenna.

10. The system of claim 1 wherein the hardware-based comparator comprises at least one of a field programmable gate array, an application-specific integrated circuit, a digital signal processor, an array of microcontrollers and external memory, and a circuit based on discrete digital components.

11. The system of claim 1 wherein the hardware-based comparator further comprises a Discrete Fourier Transform calculator for determining a Discrete Fourier Transform of the fragment prior to determining a distance between the fragment with each of the candidate samples.

12. The system of claim 1 wherein the processor operable to determine if the distance between the fragment and at least one of the candidate samples satisfies a pre-determined criterion comprises the processor operable to determine if the distance between the fragment and at least one of the candidate samples is less than a pre-determined distance threshold.

13. The system of claim 1 wherein the processor operable to classify the fragment as one of the candidate samples, based on the distance between the fragment with each of the candidate samples comprises the processor classifying the fragment of the digital program trace signal as the known program fragment sample having a distance with the fragment that is less than or equal to the distance of each of the other known program fragment samples with the fragment.

14. The system of claim 1 wherein the processor is further operable to store the fragment as a candidate sample in the database in response to determining that the pre-determined criterion is not satisfied.

15. A method for non-intrusive program tracing a device comprising:
(a) providing a database storing a plurality of candidate samples, each of the candidate samples being associated with at least one of a known portion of program code and an observed behavior;
(b) generating an analog program trace signal from at least one of power consumption and electromagnetic emission of the device;
(c) digitizing the analog program trace signal into a digital program trace signal;
(d) collecting a fragment of the digital program trace signal;
(e) using hardware to determine a distance between the fragment and each of the candidate samples simultaneously;
(f) determining if the distance between the fragment and at least one of the candidate samples satisfies a pre-determined criterion; and
(g) in response to determining that the pre-determined criterion is satisfied, classifying the fragment as one of the candidate samples, based on the distance between the fragment with each of the candidate samples.

16. The method of claim 15 wherein:
the fragment has a length, and
each of the plurality of candidate samples have a length that is shorter than or equal to the length of the fragment.

17. The method of claim 16 wherein:
(a) the fragment and each candidate sample comprises an ordered set of values; and
(b) the determining a distance between the fragment with a candidate sample comprises:
(i) for each value of the fragment, determining a unit difference between the value of the fragment and a value of each of the candidate sample having a same position within the ordered set of the candidate sample; and
(ii) for each one of the plurality of candidate samples, determining the distance between the fragment with the candidate sample based on the unit differences.

18. The method of claim 15 wherein the generating an analog program trace signal from at least one of power consumption and electromagnetic emission of the device comprises connecting a shunt resistor in series with a power line of the device.

19. The method of claim 15 wherein the generating an analog program trace signal from at least one of power consumption and electromagnetic emission of the device comprising placing an antenna in a vicinity of the device to detect electromagnetic emission.

20. The method of claim 15 further comprising determining a Discrete Fourier Transform of the fragment prior to determining a distance between the fragment with each of the candidate samples.

21. The method of claim 15 wherein the determining if the distance between the fragment and at least one of the candidate samples satisfies a pre-determined criterion comprises determining if the distance between the fragment and at least one of the candidate samples is less than a pre-determined distance threshold.

22. The method of claim 15 wherein the classifying the fragment as one of the candidate samples, based on the distance between the fragment with each of the candidate samples comprises classifying the fragment of the digital program trace signal as the known program fragment sample having a distance with the fragment that is less than or equal to the distance of each of the other known program fragment samples with the fragment.

23. The method of claim 15 further comprising storing the fragment as a candidate sample in the database in response to determining that the pre-determined criterion is not satisfied.
